(19) United States
(12) Patent Application Publication
(10) Pub. No.: US 2016/0123548 A1
(43) Pub. Date: May 5, 2016

(54) Self-powered solar illumination device with self-contained power system

(71) Applicants: Anne Marie Griffin, Florence, MA (US); Stephen Joseph Smith, Yonkers, NY (US)

(72) Inventors: Anne Marie Griffin, Florence, MA (US); Stephen Joseph Smith, Yonkers, NY (US)

(21) Appl. No.: 14/529,194

(22) Filed: Oct. 31, 2014

(51) Int. Cl. F21S 9/03; F21V 7/22; F21V 5/04; F21V 31/00; F21S 10/06; F21S 9/02

(52) U.S. Cl. CPC F21S 9/037; F21S 10/06; F21S 9/022; F21V 5/048; F21V 31/005; F21V 7/22; F21Y 2101/02

(57) ABSTRACT

The quest for efficient lighting has been around for generations. LED (light emitting diode) is an efficient way to illuminate. Predecessors like the florescent light and standard incandescent light sources proved to only generate a fraction of the light source provided by a LED. Florescent light only provides a ¼ of a LED's illumination, and a standard incandescent light provides 1/20^{th} of a LED's illumination. The self-powered device provides a compact, durable solution for efficient lighting through utilizing energy from the sun, as well as the potential to transfer solar energy to other small portable devices.

### REFERENCES CITED

U.S. Patent Documents

| | | | |
|---|---|---|---|
| 8,866,416 | October 2014 | Burrows, et al. | |
| 8,858,015 | October 2014 | Harshaw | |
| D715233 | October 2014 | Takao, et al. | |
| D715,731 | October 2014 | Nook, et al. | |
| 8,866,407 | October 2014 | Takahashi | |
| 8,853,947 | October 2014 | Asato | |
| 8,853,953 | October 2014 | Pollock, et al. | |
| 8,853,892 | October 2014 | Fells, et al. | |
| 8,508,116 | August 2013 | Negley, et al. | |
| 7,768,192 | August 2010 | Van De Ven, et al. | |
| 7,008,078 | March 2006 | Shimizu, et al. | |
| 6,817,735 | November 2004 | Shimizu, et al. | |
| 5,803,579 | September 1998 | Turnbull, et al. | |
| | May 17, 2012 | Sreshta, et al. | Appl. 13/163,230 |
| | Jul. 22, 2010 | Kugel, Jason, | Appl. 12/356,733 |
| | | J/Scharles, Brian P. | |

### OTHER REFERENCES

History of Solar Energy, Office of Energy Efficiency & Renewable Energy, www.energy.gov/eere
M. Nisa Khan (Aug. 20, 2013) Understanding LED Illumination Hardcover
Brian Clark Howard, Seth Leitmman, William Brinsky (Sep. 3, 2012) Green Lighting
Solar Power (Apr. 8, 2012) Renewable Energy, What Are Solar Panels, What is Solar Power [Green Energy, What are Solar Panels]
A. R. Jha (Oct. 14, 2009) Solar Cell Technology and Applications
Micro USB, http://www.wisageek.com/what-is-micro-usb.htm

### Brief History:

The device merges solar, LED and power transference technology. In 1947, the use of solar power finally became precedent, and began the huge demand for solar equipment to save on energy post World War II, LED technology came later.

LEDs emit a single color of light. It is comprised of a die/semiconductor material, a lead and encapsulation epoxy for protection of the die. In 1960s, the dawn of first LED was made of a semiconductor using gallium, arsenic and phosphorus (GaAsP) that emitted red light. It did not produce enough visibility in normal daylight, and was used for military purposes and known as infrared LEDs. In the 1970s, additional colors of the spectrum were introduced. Finally, in the 1980s, while LED came to advent. It was brighter, more stable and cost efficient, LEDs are used in applications such as traffic signals, automotive headlamps, cameras and more.

On Oct. 7, 2014 Isamu Akasaki, Hiroshi Amano and Shuji Nakamura was awarded the Nobel Peace Prize in Physics for the invention of efficient blue light-emitting diodes to enable energy-saving while light sources, also known as LED lamps.

### SUMMARY OF INVENTION

The device is a self-powered solar LED that encompasses a power system that could transfer energy to any small device that utilizes a micro-USB port. The device is durable, portable, water-resistant and compact (wallet-sized). It serves to illuminate a large room and/or transfer power to another device with die use of the sun as its sole power generator. It can also be charged by USB. It is equipped with solar panels to intake sunrays and eight (8) conical shapes around the LEDs to emit the white LED light. It has an interior on/off push switch to regulate the light intensity and to prevent accidental shutdowns. The device recharges during the day, and remains illuminated overnight.

### DESCRIPTION OF DRAWINGS

Assembled View, Sheet 1 of 4

Drawing#2014-2: Front and side view that includes mechanisms and dimensions.

FIG. 1: Front view with dimensions.

FIG. 2: Side view with dimensions.

FIG. 3: Bisected, Section B-B view shaded without dimensions.

Drawing# Sheet 2 of 4, CASE_BOTTOM_2014: Slide switch and Micro USB openings with dimensions and views of the bottom portion of the housing/case.

FIG. 4: Case Bottom view with attachment points including hinge location and dimensions

FIG. 5: Case End view with dimensions

FIG. 6: Case Bottom side view with hinge attachment and dimensions

Drawing# Sheet 3 of 4, SEGMENT_1: Shows PC Board bezel that displays cones and internal views and dimensions of device

FIG. 7: PC Board Bezel view with cones, hinges and dimensions.

FIG. 8: End view with dimensions.

FIG. 9. Bisected. Section B-B view with hinge attachment and dimension.

Drawing# Sheet 4 of 4, CASE_TOP_2014: Shows the top view and dimensions of the top portion of the device.

FIG. 10: Front Case Top view

FIG. 11: Case Cover End view with hinge location and dimension.

FIG. 12: Side view hinge location and dimensions.

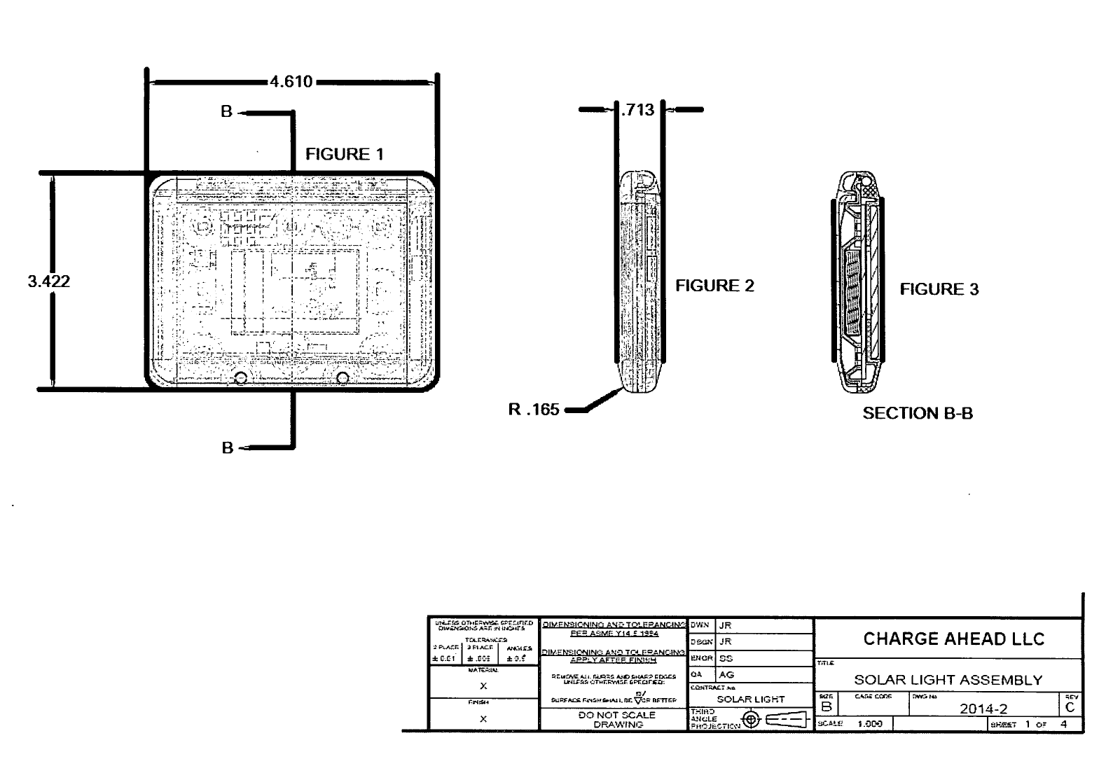

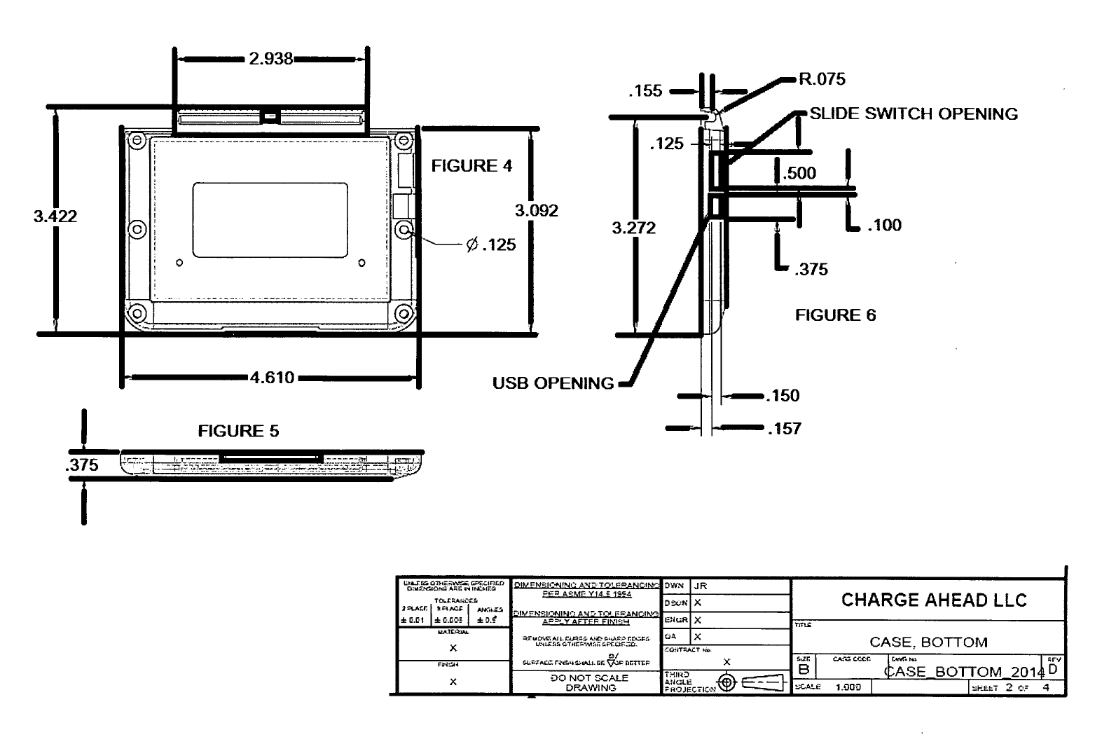

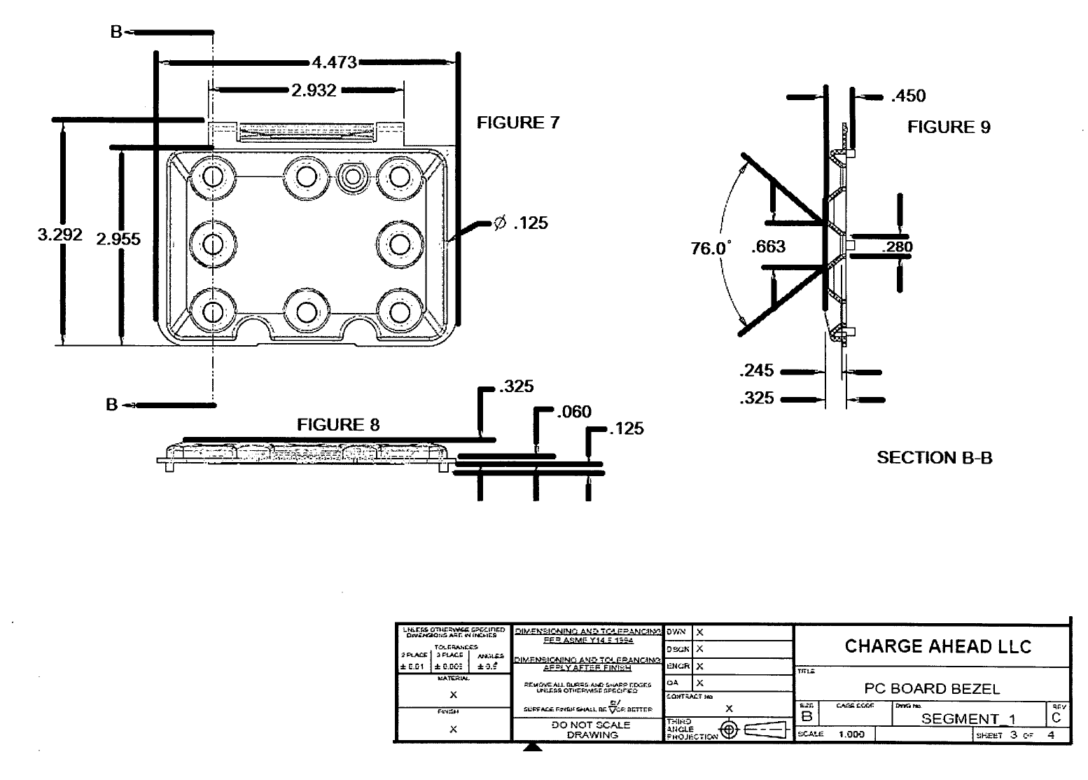

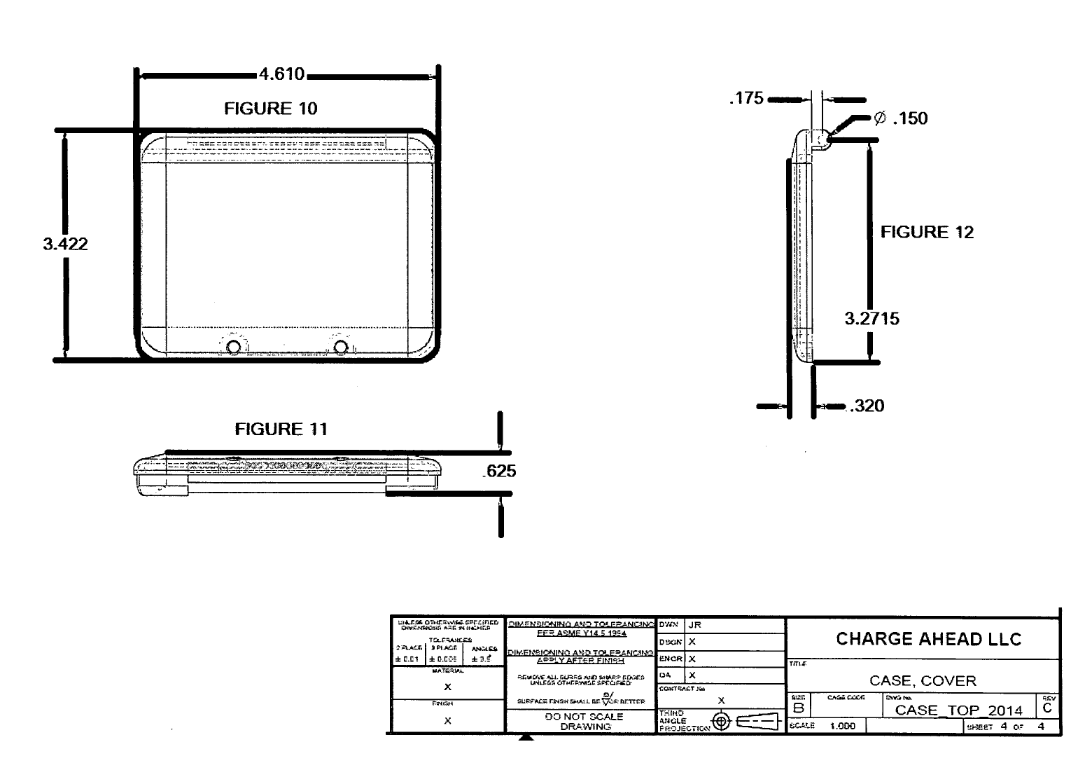

### DETAILED DESCRIPTION OF THE DEVICE

The solar powered illumination device includes an upper housing having an upper solar panel configured to receive solar light energy. A lower housing is attached with hinges to the upper housing defining a lower housing interior area in communication with the upper housing interior area. In die interior of housing contains a spring activated internal intensity settings switch to prevent accidental shutdown. Each LED is embedded in a case below a cone for protection and light diffusion. The top cover contains two (2) holes for hanging the device.

Sheet 1 of 4: Entire device center view with two (2) openings for a Multi-position switch and micro USB.

Sheet 2 of 4: Top, End A Right side view with 2 openings and dimensions.

Sheet 3 of 4: Top, End & Bisected view of PC Board heel that includes four (4) main dimensions of the conical shapes around the LEDs.

Diameter at top of cone—0.663 in

Diameter at bottom of cone—0.280 in

Height of cone—0.325 in

Included Angle of cone—76.0 degrees

Sheet 4 of 4: Case Cover Top, End & Right side views with hinge location.

1. The device is solar and self-powered. It does not rely on any other generator for energy besides the sun. However, it can be charged also by using the Micro USB port.

2. Construction of the device is compact (wallet-sized), durable (housed in a sturdy case) and water-resistant. It is constructed with an exterior 60 mm×90 mm solar panel, sturdy plastic housing and internal circuit board and connectors. Small clear plastic lens can be added to the device for LED protection. It utilizes eight (8) 20 mA bulbs rated at 65,000 Kelvin each.

3. Capacity of the device is from 3-75 lumens. It can illuminate a large room. It operates at five (5) levels. The levels are full, half, 25%, 25% strobe and night light intensity. When power of the device is depleted, it defaults to the of position.
100% Full intensity: 75 lumens
50% Half intensity: 38 lumens
25% Quarter intensity: 19 Lumens
25% Strobe intensity: 19 Lumens
Night light intensity: 3 lumens

4. Alternative features to the device are a power system used for charging small peripheral devices utilizing a micro USB connection, such as a mobile phone. Additional feature of the device serves as an emergency beacon by visually displaying a strobe mode white LED illumination for up to 48 hours.
Strobe Mode Settings:
25% Quarter intensity: 19 lumen
Strobe Mode: 48 hours
½ Second on, ½ Second off

5. The life of the device is a minimum of 2 years or 730 daily cycles based on eight (8) hours of solar charging.
Calculated cycle battery life:
100% Full intensity: 6 hours
50% Half intensity: 12 hours
25% Quarter intensity 24 hours
25% Strobe intensity: 41 hours
Night light intensity: 200 hours

6. The device maintains functionality when one (1) or more LEDs rails or is damaged, in that the others remain lit.

7. To maintain maximum life of the device, fully drain and fully charge the power source during the first three (3) charging and discharging cycles.

8. A moisture indicator is located inside the device to indicate mishandling of device.

9. The inside of the top cover is of a reflective nature to increase light output.
